(19) United States
(12) Patent Application Publication
(10) Pub. No.: US 2008/0303513 A1
(43) Pub. Date: Dec. 11, 2008

(54) Wireless active wheel speed sensor

(75) Inventor: Jason D. Turner, Dearborn Heights, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(73) Assignee: Kelsey-Hayes Company

(21) Appl. No.: 11/811,300

(22) Filed: Jun. 8, 2007

(51) Int. Cl. G01P 3/42

(52) U.S. Cl. 324/160

(57) ABSTRACT

A wireless rotational speed sensor system that includes a coil wound around a permanent magnet, the coil co-operating with a rotating ferrous target to induce a voltage for powering an active speed sensor element. The active speed sensor generates an output signal that is a function of the rotational speed of the target. The output signal is supplied to a wireless transmitter and antenna for transmission to other electronic components.

### BACKGROUND OF THE INVENTION

This invention relates in general to wheel speed sensors systems and in particular to a wireless active wheel speed sensor.

Vehicle wheel speed sensor systems are well known. Vehicle wheel angular velocity is used for numerous measurement devices and control systems, including but not limited to vehicle speedometer readings, vehicle cruise control, vehicle antilock braking systems, electronic stability programs, telematic systems, and roll stability programs. Speed sensor systems typically operate by means of a target with alternating magnetic poles or alternating ferrous geometry installed on a rotating wheel end component. This target is paired with a stationary sensor mounted to a wheel end static component and is separated from the stationary sensor by an air gap. The stationary sensor generates a signal when the moving target passes over a read component of the sensor. Dependent upon the technology employed, the robustness of the output signal may be dependent on the velocity with which the target passes over the sensor read component. The frequency of signals generated by the passing of the target over the read component of the sensor is then converted to a rotating speed and passed on to the appropriate measurement device or control system.

Vehicle wheel speed sensors are typically grouped into two types, active sensors and passive sensors. Passive sensors do not require a power supply in order to operate. In a passive sensor system, the function of which is governed by Faraday's Law, the stationary sensor is a permanent magnet, copper coil, and metal assembly that generates a voltage signal dependent on and representative of the velocity of which the alternating geometry of the ferrous target passes over the metal component. The stationary sensor detects a change in the magnetic field's reluctance caused by the moving target, typically a toothed wheel made of ferrous material, as it passes through the magnetic field. The output of a passive wheel speed sensor is a raw sinusoid signal that varies with the rotational speed of the vehicle wheel. In addition, passive wheel speed sensor systems require smaller dimensional tolerances of components that lend to the gap between the sensor read component and the target.

Active wheel speed sensors represent the prominent technology being utilized in vehicle wheel speed sensing devices. Active wheel speed sensors are devices which typically utilize one of two magnetic principles, and are well known in the art as Hall effect devices and magneto-resistive devices. Active wheel speed sensors require a power supply to operate the detection device and are further divided into two categories, back-biased wheel speed sensors and forward-biased wheel speed sensors. Back-biased wheel speed sensors generate a magnetic field from a permanent magnet that is positioned behind the active sensing element of the stationary sensor, while the moving target is constructed of a ferrous material with alternating geometry, as typically employed in passive wheel speed sensor systems. Forward biased wheel speed sensors, conversely, utilize a magnetic field generated by the moving target, such as a wheel comprised of alternating north and south magnetic poles. Because the magnetic field is generated from the target, forward-biased wheel speed sensors do not need magnets, require correspondingly fewer components and are thus smaller than back-biased wheel speed sensors. However, forward biased wheel speed sensors require a more complex, and hence more expensive, target than back-biased wheel speed sensors.

Both back-biased and non back-biased wheel speed sensors detect the frequency of the changes in the reluctance of a magnetic field caused by the rotating target and generate a corresponding output that is supplied to an measurement device or control system. Active wheel speed sensors are generally smaller than passive wheel speed sensors, can function at slower rotational speed, are more immune to false signals due to vibration, and are capable of functioning with a greater air gap to the target than passive wheel speed sensors. Therefore, active vehicle wheel speed sensors play a large role in the improvement of vehicle control system function and performance as well as in the development of future vehicle control systems.

It is a continuing goal in wheel speed sensor design to reduce the size of the various components, which leads to greater packaging flexibility and generic design opportunities. One restriction upon utilization of active wheel speed sensors is the need to hard wire the sensor to a vehicle electrical system in order to provide paths for supplying power to the sensor and to communicate sensor output signals to vehicle control systems. Such hard wiring not only adds complexity and cost, but also can result in limitations regarding the placement of the sensor upon the vehicle. Additionally, the wiring is included in the vehicle wheel wells and thus may be exposed to damage from suspension and steering components, road debris and/or corrosion from water and salt thrown up into the wheel well by the vehicle wheel. Accordingly, it would be desirable to provide a wireless active wheel speed sensor to eliminate the need for providing hard wiring the sensor into the vehicle electrical system.

### BRIEF SUMMARY OF THE INVENTION

This invention relates to a wireless active wheel speed sensor.

The present invention contemplates a wireless active rotational speed sensor that includes a permanent magnet formed as a pole piece with an active sensor element attached to an end of the pole piece. The sensor system also includes a target, or tone wheel, formed from a ferrous material and having a plurality of teeth formed upon the periphery thereof, the target being adjacent to the active sensor element. The wireless active rotational speed sensor is characterized in that a wire coil is wrapped around the magnetically biased pole piece and connected to the active sensor element with the rotating target co-operating with the pole piece to generate a varying magnetic field that induces a voltage across the coil to supply an electric current to the active sensor element. The wireless active rotational speed sensor further includes a transmitter and antenna for wireless transmission of the sensor element output signal.

In another aspect of the present invention, the wireless active rotational speed sensor system may include a rechargeable energy storage device, such as a backup battery or a capacitor, and a control circuit for supplying power to the components of the sensor when the target is not rotating or rotating at an insufficient speed to supply the needed power. The power control circuit also would be operable to charge the energy storage device as needed when excess energy is available from the coil. The wireless active rotational speed sensor also may include a sleep/wake up circuit that deactivates the speed sensor until an actuation command is received from a vehicle control system, whereupon the sleep/wake up circuit actuates the speed sensor.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic diagram of a wireless active wheel speed sensing system in accordance with the present invention.

FIG. 2 is a schematic diagram of an alternate embodiment of the wireless active wheel speed sensing system shown in FIG. 1.

FIG. 3 is a schematic diagram of another alternate embodiment of the wireless active wheel speed sensing system shown in FIG. 1.

### DETAILED DESCRIPTION OF THE PREFERRED EMBODIMENT

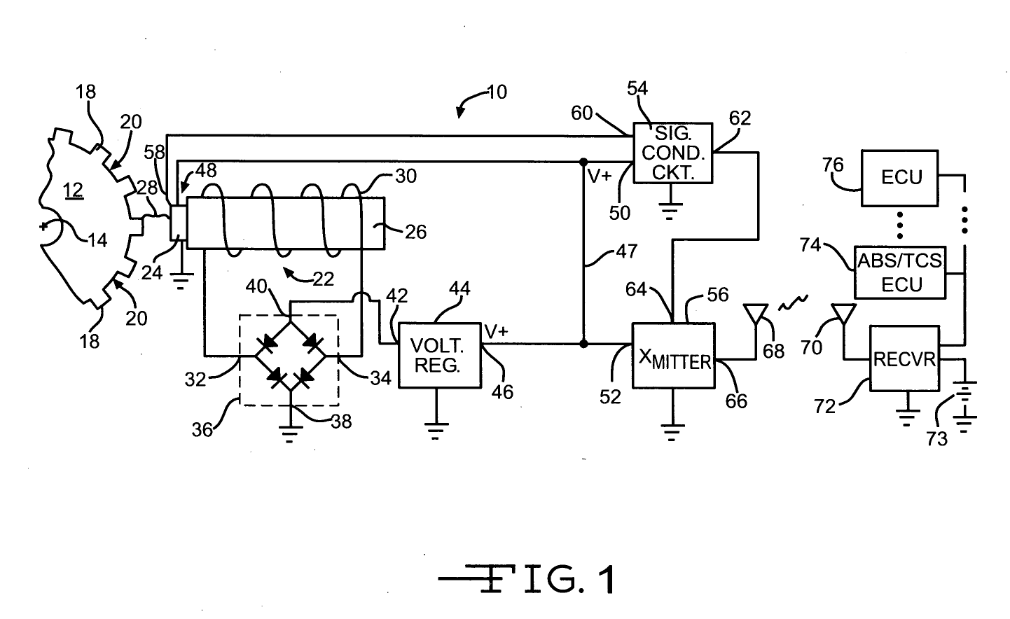

Referring to FIG. 1, a wireless vehicle wheel speed sensor in accordance with the present invention is shown generally at 10. The wheel speed sensor 10 detects the rotational velocity of a tone wheel 12, also known as an exciter wheel or exciter ring, tone ring, or target, as the tone wheel rotates about an axis 14. The tone wheel 12 is generally circular and includes a plurality of teeth 18 protruding from and spaced equally about its periphery. The individual teeth 18 are separated by spaces 20. The tone wheel 12 is formed from a ferrous material, such as iron or steel or an alloy thereof. The tone wheel 12 is adapted to be mounted upon a rotatable vehicle component (not shown), such as, for example, a vehicle wheel or wheel hub. Thus the tone wheel 12 rotates at the same angular velocity as the vehicle wheel being monitored.

The wireless wheel speed sensor 10 includes a sensor assembly 22, which includes an active sensing element or device 24 mounted upon one end of to a pole piece 26 comprising a magnetically biased permanent magnet. The sensing device 24 may be either a conventional Hall effect device or a conventional magneto-resistive device. The radial distance between the periphery of the tone ring 12 and the sensor 24 is called the air gap 28. The sensor 24 is oriented to project inwardly toward the axis of rotation 14. Thus, the sensor assembly 22 is configured as a back-biased sensor with the pole piece 26 acting as the back-biasing magnet for the active sensor device 24. The sensor assembly 22 also includes a wire coil 30 wound around the pole piece 26. The wire coil is formed from an electrically conductive material, such as, for example, copper.

As shown in FIG. 1, both ends of the coil 30 are connected to a pair of input terminals 32 and 34 of a full wave bridge rectifier 36. While a full wave bridge rectifier 36 is shown in FIG. 1, it will be appreciated that the invention also may be practiced with a half wave rectifier or any other conventional rectification device. The full wave rectifier 36 also has a pair of output terminals 38 and 40. One of the output terminals 38 of the rectifier 36 is connected to ground while the other of the output terminals 40 is connected to the input terminal 42 of a conventional voltage regulator 44. The voltage regulator 44 has a voltage output terminal 46 that is connected to a power supply bus 47 that is in turn connected to a power input terminal 48 of the active sensing device 18. As also shown in FIG. 1, the power supply bus 47 is also connected to power supply terminals 50 and 52 of a signal conditioning circuit 54 and a wireless transmitter circuit 56, respectively. Alternately, the voltage regulator voltage output terminal 46 may be connected directly to the power input terminals 48, 50 and 52 of the components described in the preceding.

The active sensing device 24 also has an output signal terminal 58 that is connected to an input terminal 60 of the signal conditioning circuit 54. The signal conditioning circuit 54 is a conventional circuit that amplifies, filters and otherwise modifies the output of the active sensing device 46 as needed to be compatible with the other vehicle systems. The signal conditioning circuit, which may include an amplification stage, low pass RC filter, and/or band pass filter 54 generates an output signal at output terminal 62. The output signal is either an analog signal or, if the circuit 54 includes an analog to digital converter, a digital signal. The signal conditioning circuit output terminal 62 is connected to an input terminal 64 of the wireless transmitter circuit 56.

The transmitter circuit 56 is a conventional short range transmitter circuit such as, for example, the transmitter circuit used in keyless entry systems, or another wideband transmitter circuit, that modulates the conditioned output signal onto a radio frequency carrier signal for transmission. The transmitter circuit 56 has an output terminal 66 that is connected to a short range wireless antenna 68. As shown in FIG. 1, the electrical components of the wheel speed sensor 10, namely, the active sensing device 24, the full wave rectifier 36, the voltage regulator 44, the signal conditioning circuit 54 and the transmitter circuit 56, are all connected to a common ground. As an alternative, the invention may be practiced with the component grounds wired together via a printed circuit board trance and/or hard wiring (not shown).

The transmitter circuit and antenna 56 and 68 co-operate with a receiving antenna 70 and receiver circuit 72 that are mounted upon the vehicle. The receiving antenna 70 may be located either in proximity to the transmitting antenna 68 or in a central location within the vehicle. The receiver circuit 72 receives power from the vehicle power supply, which is represented in FIG. 1 by storage battery that is labeled 73. The receiver circuit 72 demodulates the conditioned output signal from the radio frequency carrier signal to generate an output wheel speed signal that is supplied as an input signal to one or more Electronic Control Units (ECU) for vehicle control systems. Typical ECU's may include an Anti-Lock Brake System/Traction Control System (ABS/TCS) ECU 74, as shown in FIG. 1 and/or any number of other ECU's 76.

The operation of the wheel speed sensor 10 will now be explained. As the tone wheel 12 rotates the individual teeth 18 and the spaces 20 sweep past the end of the pole piece 26 causing the length of the air gap 28 to fluctuate. The air gap length fluctuation causes the magnetic flux generated between the tone wheel 12 and the pole piece 26 to alternately increase and decrease. The alternating magnetic flux induces an alternating voltage across the coil. The induced alternating voltage is applied to the full wave rectifier 36 to produce a pulsing signal that is input to the voltage regulator 44. The voltage regulator produces a constant dc voltage that provides power to the active sensing device 24, the signal conditioning circuit 54 and the transmitter 56.

The active sensing device 24 is responsive to the changing reluctance of the magnetic field established between the target 12 and the pole piece 26 to generate a varying voltage representing a wheel speed signal with the variation being a function of the rotational speed of the tone wheel 12. The wheel speed signal is modified by the signal compensation circuit 54 and the resulting modified wheel speed signal is applied the input of the transmitter circuit 56. As described above, the modified wheel speed signal may be either an analog or a digital signal. The transmitter circuit 56 may either continuously transmit the wheel speed signal though the antenna 68 or transmit the signal upon being prompted by the receiver circuit 72. The later course of action would be useful where each vehicle wheel is provided with a wireless wheel speed sensor and the wheel speeds would be sequentially transmitted to receiver circuit 72. Also, for implementation of the later configuration, the invention contemplates replacing each of the transmitter and receiver circuits 52 and 72 with a combined transmitter/receiver circuit, such as described below, that would allow transmitting the prompt from the vehicle ECU's to the wheel speed sensor 10. Alternately, an initiator circuit (not shown) may be included to prompt the operation of the wheel speed sensor 10.

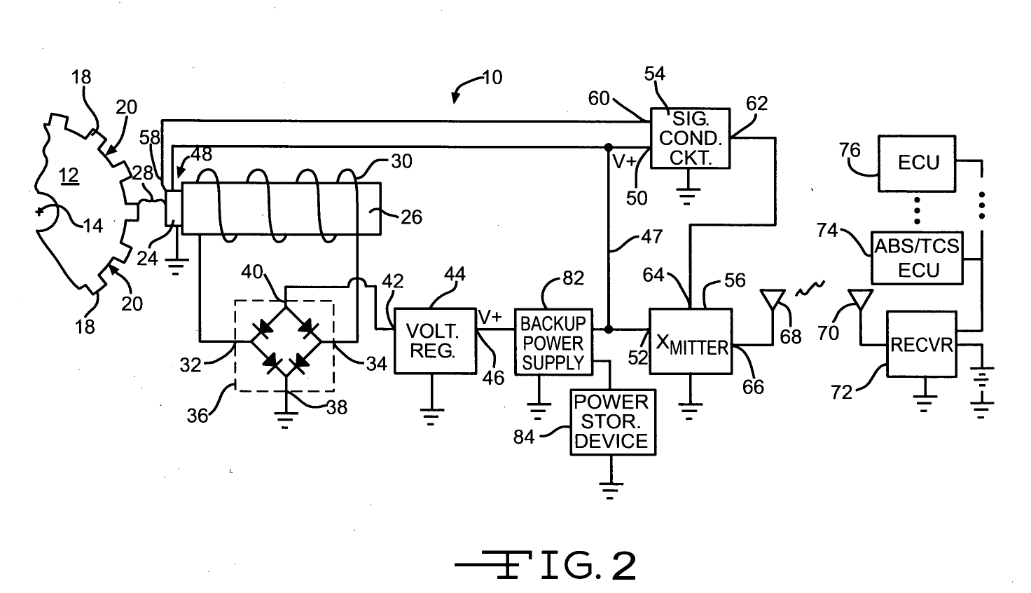

An alternate embodiment 80 of the wheel speed sensor is shown in FIG. 2 where components that are similar to components shown in FIG. 1 have the same numerical identifiers. The wheel speed sensor 80 includes a backup power supply 82 connected between the output terminal of the voltage regulator circuit 44 and the power supply bus 47. The backup power supply 82 includes a rechargeable energy storage device 84, such as, for example, a lithium battery or other type of rechargeable battery, or a capacitor for shorter term power loss (not shown), and includes control circuitry (not shown) that functions to supply power to the wheel speed sensor components when the tone wheel is either stationary or turning at a low speed that is insufficient to generate the needed power for the components. Similarly, the power supply control circuitry also functions to charge the energy storage device 84 when the tone wheel 12 is rotating at higher speeds that are sufficient to cause the coil 30 to generate excess power.

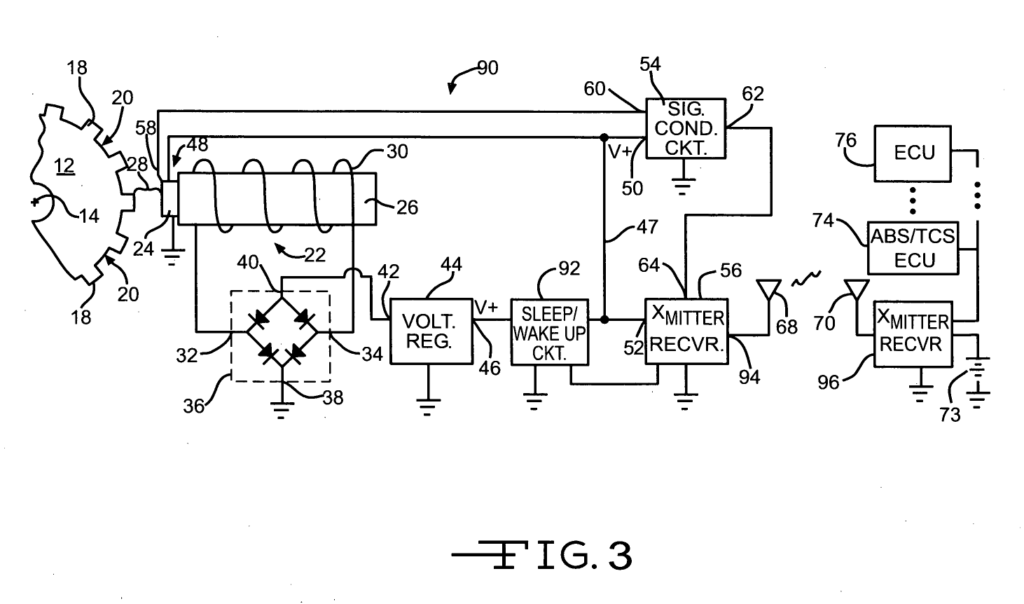

Another alternate embodiment 90 of the wheel speed sensor is shown in FIG. 3 where components that are similar to components shown in FIG. 1 have the same numerical identifiers. The wheel speed sensor 90 includes a sleep/wakeup circuit 92 connected between the output terminal of the voltage regulator circuit 44 and the power supply bus 47. The sleep/wakeup circuit 92 includes an electronic switch (not shown) that disconnects the power supply from the other circuit components when there is no activity or a wheel speed signal is not desired. The switch is closed to activate the wheel speed sensor 90 upon the sleep/wakeup circuit 92 receiving an activation command from one of the vehicle ECU's. Accordingly, each of the transmitter and receiver circuits 52 and 72 shown in FIG. 1 has been replaced in FIG. 3 by a combined transmitter/receiver circuit 94 and 96. The transmitter/receiver circuit 94 that is shown in the left portion of FIG. 3 is connected by an output line 96 to the sleep/wakeup circuit 92. The output line 96 transmits the activation command to the sleep/wakeup circuit 92. Once activated, the sensor remains active until either a predetermined time period elapses or a de-actuation command is received from the vehicle ECU that sent the activation command. It will be appreciated that the sleep/wakeup circuit 92 shown in FIG. 3 also may be included in the alternate embodiment 80 shown in FIG. 2 (not shown). Additionally, the sleep/wakeup circuit 92 also may be utilized as the initiator circuit described above.

While the wireless wheel speed sensor 10 has illustrated and described above as being used to monitor wheel speed, it will be appreciated that the sensor circuit also may be utilized to measure other rotational speeds of vehicle components. Thus, the sensor 10 also may be used to monitor shaft speeds within a transmission or engine crankshaft speeds, to name two possible applications. Also, the invention contemplates optionally including a microprocessor (not shown) that would be used to control the various sensor components.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope. For example, other sensor configurations and locations are considered to be within the scope of the present invention.

What is claimed is:

1. A wheel speed sensor comprising:
a permanent magnet formed as a pole piece;
an active sensor element attached to an end of said pole piece;
a rotatable target formed from a ferrous material, said target being adjacent to said active sensor element; and
characterized in that a wire coil is wrapped around said pole piece and connected to said sensor element with said rotating target co-operating with said pole piece to generate a varying magnet field that induces a voltage across said coil to supply an electric current to said active sensor element.

2. The speed sensor according to claim 1 wherein said active sensor element produces an output speed signal that is a function of the rotational speed of said target and further wherein the sensor includes a transmitter circuit having an input electrically connected to said active sensor element and powered by said induced voltage, said transmitter circuit also having an output connected to an antenna, said transmitter circuit operative to generate a modulated output speed signal and to transmit said modulated through said antenna.

3. The speed sensor according to claim 2 wherein said target has a plurality of teeth formed upon the periphery thereof.

4. The speed sensor according to claim 3 wherein said target is a tone wheel.

5. The speed sensor according to claim 3 further including a rectification device having an input connected to said coil, said rectification device also having an output electrically connected to said active sensor element.

6. The speed sensor according to claim 5 further including a voltage regulation circuit electrically connected between said rectification device output and said active sensor element, said voltage regulation circuit also electrically connected to said transmitter circuit and operative to supply a regulated voltage to said active sensor element and said transmitter circuit.

7. The speed sensor according to claim 6 further including a signal conditioning circuit connected between said sensor element and said transmitter circuit, said signal conditioning circuit receiving power from said voltage regulation circuit and operative to modify said output speed signal.

8. The speed sensor according to claim 7 wherein said active sensor element is a Hall effect device.

9. The speed sensor according to claim 7 wherein said active sensor element is a magneto-resistive device.

10. The speed sensor according to claim 7 further including a backup power circuit connected to a backup energy storage device, said backup power circuit connected to the output of said voltage regulator circuit and operative to one of charge said backup energy storage device when excess power is available and draw power from said backup energy storage device when insufficient power is available for the speed sensor components.

11. The speed sensor according to claim 10 wherein said energy storage device includes a rechargeable battery.

12. The speed sensor according to claim 10 wherein said energy storage device includes a capacitor.

13. The speed sensor according to claim 7 further including a sleep/wake up circuit connected to said voltage regulator circuit, said sleep/wake up circuit operable to actuate said active speed sensor upon receiving an actuation command.

14. The speed sensor according to claim 13 wherein said actuation command is generated by a vehicle control system.

15. The speed sensor according to claim 13 wherein said sleep/wake up circuit also is operative to de-actuate said active speed sensor after a predetermined time period has passed.

16. The speed sensor according to claim 13 further including a receiver connected to said sleep/wake up circuit, said receiver receiving power from said voltage regulator circuit and operative to receive said actuation command and transmit said command to said sleep/wake up circuit.

17. The speed sensor according to claim 16 wherein said transmitter and said receiver are combined in a single wireless device, said wireless device being connected to a common transmitting/receiving antenna.
